(19) United States
(12) Patent Application Publication
(10) Pub. No.: US 2016/0227828 A1
(43) Pub. Date: Aug. 11, 2016

(54) SUBSTANTIALLY CLEAR NUTRITIONAL LIQUIDS HAVING IMPROVED SENSORY CHARACTERISTICS

(71) Applicant: ABBOTT LABORATORIES, Abbott Park, IL (US)

(72) Inventors: TIMOTHY CHAPMAN, Grove City, OH (US); KELLEY LOWE, Powell, OH (US); NORMANELLA DEWILLE, Columbus, OH (US)

(73) Assignee: ABBOTT LABORATORIES, Abbott Park, IL (US)

(21) Appl. No.: 14/979,717

(22) Filed: Dec. 28, 2015

Related U.S. Application Data
(60) Provisional application No. 62/112,478, filed on Feb. 5, 2015.

(51) Int. Cl. A23L 1/302

(52) U.S. Cl. CPC A23L 1/302; A23L 1/304; A23L 1/3056; A23L 1/30; A23V 2002/00

(57) ABSTRACT

Disclosed are substantially clear nutritional liquids which include protein and are substantially free of vitamin C. The liquids have a pH of from about 2.8 to about 4.6 and may be manufactured as a hot fill product. The substantially clear nutritional liquids may include malic acid and have a lesser amount of citric acid or otherwise be substantially free of citric acid. The substantially clear nutritional liquids may also be substantially free of fat.

### CROSS-REFERENCE TO RELATED APPLICATIONS

This application claims priority to and the benefit of U.S. Provisional Patent Application No. 62/112,478, filed Feb. 5, 2015, the entire content of which is incorporated by reference herein.

### FIELD

The present disclosure is directed generally to nutritional compositions and more particularly to acidic nutritional compositions having improved sensory characteristics.

### BACKGROUND

Nutritional supplements are widely commercially available and are generally intended to supplement other nutritional sources. Currently available nutritional supplements include both emulsified supplements (generally “milk-based” supplements) and non-emulsified supplements (“clear” supplements). Many individuals today prefer to utilize clear supplements as they can provide a thin, good-tasting, and refreshing means of supplementing energy, protein, vitamins, and minerals. A conventional clear liquid nutritional supplement is disclosed in U.S. Pat. No. 5,641,531, the entire disclosure of which is incorporated herein by reference.

Conventional clear supplements often exhibit undesirable sensory characteristics. For example, protein in the clear supplement may contribute to one or more of a dry, astringent, and lingering aftertaste. As another example, the combination of vitamins and minerals in the clear supplement may contribute to off-notes in flavor (e.g., a metallic aftertaste) and aroma. As yet another example, an acidulant present in the clear supplement may contribute to a sour taste, mouth irritation, and throat catch.

Accordingly, there is a need for a clear supplement (e.g., a substantially clear nutritional liquid) that exhibits improved sensory characteristics.

### SUMMARY

The general inventive concepts contemplate substantially clear nutritional compositions that exhibit improved sensory characteristics. The substantially clear nutritional compositions will typically be acidic liquids having a pH of 4.6 or less. The substantially clear nutritional compositions will typically be substantially free of fat. The substantially clear nutritional compositions will be substantially free of vitamin C. The substantially clear nutritional compositions will typically include malic acid, and will have a reduced citric acid content or be substantially free of citric acid. The substantially clear nutritional compositions will have a controlled (e.g., limited) amount of protein.

In one exemplary embodiment, a substantially clear liquid nutritional composition has a pH of less than or equal to 4.6. The substantially clear liquid nutritional composition comprises: at least one source of protein, and at least one of a vitamin and a mineral. The substantially clear liquid nutritional composition has a total protein content of 1 wt % to 10 wt % per serving of the substantially clear liquid nutritional composition. The substantially clear liquid nutritional composition is substantially free of fat. The substantially clear liquid nutritional composition is substantially free of vitamin C.

In one exemplary embodiment, the total concentration of protein in the substantially clear liquid nutritional composition is controlled so as to not exceed about 10%, and may range from about 0.5% to about 10%, including from about 1% to about 10%, including from about 2% to about 10%, including from about 3% to about 10%, including from about 4% to about 10%, and also including from about 5% to about 10%, by weight of the substantially clear liquid nutritional composition.

In one exemplary embodiment, the total protein content of the substantially clear liquid nutritional composition is from 2 g to 10 g per serving. In one exemplary embodiment, the total protein content of the substantially clear liquid nutritional composition is no more than 8 g per serving. In one exemplary embodiment, the total protein content of the substantially clear liquid nutritional composition is approximately 8 g per serving.

In one exemplary embodiment, the at least one source of protein comprises whey protein. In one exemplary embodiment, whey protein is the sole source of protein in the substantially clear liquid nutritional composition. In one exemplary embodiment, the whey protein is selected from the group consisting of whey protein isolate, whey protein concentrate, hydrolyzed whey protein, and combinations thereof.

In one exemplary embodiment, the total protein content of a serving of the substantially clear liquid nutritional composition comprises from 65 wt % to 100 wt % soluble protein.

In one exemplary embodiment, the substantially clear liquid nutritional composition comprises a plurality of vitamins. In one exemplary embodiment, the substantially clear liquid nutritional composition comprises at least ten vitamins. In one exemplary embodiment, the substantially clear liquid nutritional composition comprises a plurality of vitamins selected from the group consisting of: Vitamin A, Vitamin D, Vitamin K, Riboflavin, Vitamin B6, Vitamin B12, Pantothenic Acid, Vitamin E, Thiamin, Niacin, Folic Acid, Biotin, and combinations thereof.

In one exemplary embodiment, the substantially clear liquid nutritional composition comprises a plurality of minerals. In one exemplary embodiment, the substantially clear liquid nutritional composition comprises at least four minerals. In one exemplary embodiment, the substantially clear liquid nutritional composition comprises a plurality of minerals selected from the group consisting of: Calcium, Iodine, Zinc, Copper, Chromium, Iron, Phosphorus, Magnesium, Selenium, Manganese, Molybdenum, Sodium, Potassium, and combinations thereof.

In one exemplary embodiment, the substantially clear liquid nutritional composition comprises a plurality of vitamins and a plurality of minerals.

In one exemplary embodiment, the substantially clear liquid nutritional composition has a pH of between 2 and 4.6. In one exemplary embodiment, the substantially clear liquid nutritional composition has a pH of between 2.8 and 3.4.

In one exemplary embodiment, the substantially clear liquid nutritional composition further comprises an acidulant. In one exemplary embodiment, the acidulant is malic acid. In one exemplary embodiment, the substantially clear liquid nutritional composition comprises malic acid and is substantially free of citric acid. In one exemplary embodiment, the substantially clear liquid nutritional composition comprises malic acid and citric acid, wherein the concentration of the malic acid in the composition is greater than the concentration of the citric acid.

In one exemplary embodiment, the substantially clear liquid nutritional composition further comprises at least one source of carbohydrate. In one exemplary embodiment, the at least one source of carbohydrate is selected from the group consisting of: sucrose, maltodextrin, corn syrup solids, sucromalt, maltitol powder, glycerine, glucose polymers, corn syrup, modified starches, resistant starches, rice-derived carbohydrates, isomaltulose, white sugar, glucose, fructose, lactose, high fructose corn syrup, honey, sugar alcohols, fructooligosaccharides, soy fiber, corn fiber, guar gum, konjac flour, polydextrose, Fibersol, and combinations thereof.

In one exemplary embodiment, the substantially clear liquid nutritional composition further comprises at least one ingredient selected from the group consisting of natural flavors, artificial flavors, natural colorants, artificial colorants, natural sweeteners, artificial sweeteners, and combinations thereof.

In one exemplary embodiment, the substantially clear liquid nutritional composition further comprises at least one high intensity sweetener. In one exemplary embodiment, the at least one high intensity sweetener is selected from the group consisting of: sucralose, stevia, monk fruit, acesulfame potassium, and combinations thereof.

In one exemplary embodiment, the substantially clear liquid nutritional composition comprises less than 1 wt % of fat.

In one exemplary embodiment, the substantially clear liquid nutritional composition is shelf stable.

By way of example to illustrate various aspects of the general inventive concepts, several exemplary embodiments of the nutritional compositions are disclosed or otherwise suggested herein.

### DETAILED DESCRIPTION

Several illustrative embodiments will be described in detail with the understanding that the present disclosure merely exemplifies the general inventive concepts. While embodiments encompassing the general inventive concepts may take various forms, the general inventive concepts are not intended to be limited to the specific embodiments described herein.

The term “nutritional composition” as used herein, unless otherwise specified, refers to nutritional liquids and nutritional powders (i.e., “powdered nutritional compositions”), the latter of which may be reconstituted to form a nutritional liquid, all of which result in a substantially clear nutritional liquid comprising at least one source of protein and being suitable for oral consumption by a human. In general, the nutritional liquids and reconstituted nutritional powders are referred to herein collectively as “liquid nutritional compositions.”

The term “substantially clear” as used herein, unless otherwise specified, refers to a visibly sheer appearance. Translucency in this context may be measured by formazin nephelometric unit (FNU) at 90 degree light scattering and a wavelength of 860 nm with a Nephla reader. A substantially clear liquid nutritional composition, as used herein, refers to a liquid nutritional composition with a turbidity FNU of less than or equal to 5,000 (e.g., 50 to 5,000), including less than or equal to 4,000 (e.g., 50 to 4,000), less than or equal to 3,000 (e.g., 50 to 3,000), less than or equal to 2,000 (e.g., 50 to 2,000), less than or equal to 1,000 (e.g., 50 to 1,000), less than or equal to 750 (e.g., 10 to 750), less than or equal to 500 (e.g., 10 to 500), less than or equal to 300 (e.g., 10 to 300), less than or equal to 250 (e.g., 10 to 250), less than or equal to 100 (e.g., 10 to 100), less than or equal to 50 (e.g., 3 to 50), less than or equal to 40 (e.g., 3 to 40), less than or equal to 30 (e.g., 3 to 30), and less than or equal to 20 (e.g., 0 to 20).

The terms “fat” and “oil” as used herein, unless otherwise specified, are used interchangeably to refer to lipid materials derived or processed from plants or animals. These terms also include synthetic lipid materials so long as such synthetic materials are suitable for oral administration to humans.

The term “minerals” as used herein, unless otherwise specified, refers to any one of major minerals, trace or minor minerals, other minerals, and combinations thereof. Major minerals include calcium, phosphorus, potassium, sulfur, sodium, chlorine, magnesium. Trace or minor minerals include iron, cobalt, copper, zinc, molybdenum, iodine, selenium, manganese and other minerals include chromium, fluorine, boron, lithium, and strontium.

The term “substantially free” as used herein, unless otherwise specified, refers to a substance that contains less than a functional amount of an ingredient, typically less than about 1%, including less than about 0.5%, including less than about 0.1%, and also including zero percent, by weight of such ingredient.

The term “shelf stable” as used herein, unless otherwise specified, refers to a substantially clear nutritional liquid that remains commercially stable after being packaged and then stored at 18° C. to 24° C. for at least 3 months, including from about 6 months to about 24 months, and also including from about 12 months to about 18 months.

Improved sensory characteristics refers to the enhancement of (including the reduction of negative) organoleptic properties associated with conventional nutritional compositions. For example, the inventive nutritional compositions may exhibit improved taste and/or aroma.

Generally, the inventive nutritional compositions will reduce or otherwise eliminate one or more undesirable sensory characteristics, such as a dry, astringent, or lingering aftertaste; off-notes in flavor (e.g., a metallic aftertaste) or aroma; and a sour taste, mouth irritation, or throat catch.

Astringency is a tactical sensation defined as a complex group of sensations involving dryness and roughness of oral surfaces and tightening, drawing, or puckering of the mucosa and muscles around the mouth. Astringency is a commonly known shortcoming in the food industry for acidified whey protein containing beverages. The astringency is believed to be caused by the positively charged whey proteins interacting with the negatively charged salivary proteins. This interaction causes the proteins to aggregate and precipitate in the mouth and lead to an undesirable dry puckering mouthfeel.

Throat catch refers to a sensation that makes you want to clear your throat after a product (e.g., a particular composition) is swallowed.

The inventors have found that formulation of a substantially clear liquid nutritional composition without any vitamin C improves the sensory characteristics (e.g., taste, aroma) of the nutritional composition as compared to a similar nutritional composition including a nutritionally significant amount of vitamin C. Surprisingly, removal of vitamin C from a mixture of several vitamins and minerals was effective in improving the overall sensory characteristics of the nutritional composition. Thus, the inventive nutritional composition will typically include one or more vitamins (other than vitamin C) and one or more minerals. In particular, the liquid nutritional composition being substantially free of vitamin C exhibited a notable reduction in off-notes in flavor, aroma, and aftertaste.

The substantially clear nutritional composition is an acidic liquid having a pH of 4.6 or less. The substantially clear liquid nutritional composition is substantially free of fat.

In addition to being substantially free of vitamin C, the substantially clear liquid nutritional composition will also have a minimized, reduced, or otherwise eliminated amount of citric acid. The substantially clear liquid nutritional composition may include a food grade acidulant other than citric acid. In particular, in some exemplary embodiments, the substantially clear liquid nutritional composition comprises malic acid. The inventors have found that formulation of a substantially clear liquid nutritional composition with malic acid improves the sensory characteristics (e.g., taste, mouthfeel) of the nutritional composition as compared to a similar nutritional composition including citric acid. In particular, a liquid nutritional composition comprising malic acid and being substantially free of citric acid exhibited a notable reduction in mouth irritation, sour taste, and throat catch. In some exemplary embodiments, the substantially clear liquid nutritional composition comprises malic acid and citric acid, wherein the concentration of the malic acid in the composition is greater than the concentration of the citric acid.

The substantially clear liquid nutritional composition comprises a source of protein. In some exemplary embodiments, the source of protein is whey protein. The amount of protein in a serving of the nutritional composition is limited or otherwise controlled. For example, the total protein in a serving of the liquid nutritional composition is limited to 1 wt % to 10 wt % of the nutritional composition. In some exemplary embodiments, a serving of the liquid nutritional composition has no more than 8 g of protein. The inventors have found that limiting the amount of protein in a substantially clear liquid nutritional composition improves the sensory characteristics (e.g., mouthfeel) of the nutritional composition as compared to a similar nutritional composition with a higher protein content.

### Product Form

In some exemplary embodiments, the liquid nutritional composition is a low viscosity liquid comprising 1 wt % to 10 wt % protein (e.g., whey protein) based on the total weight of the composition. Thus, the liquid nutritional composition may and typically will have a thin or watery texture with a consistency similar to that of a clear juice. In some exemplary embodiments, the liquid nutritional composition includes a water-based fluid. In some exemplary embodiments, the water-based fluid is juice, including fruit juice, vegetable juice, and combinations thereof. In some exemplary embodiments, the liquid nutritional composition has a viscosity of less than about 25 centipoise as determined by a Brookfield viscometer at 22° C. using a #1 spindle at 60 rpm. The liquid nutritional composition is typically a flowable or drinkable liquid at from about 1° C. to about 25° C.

The liquid nutritional composition is acidic. In some exemplary embodiments, the liquid nutritional composition has a pH of 4.6 or below. In some exemplary embodiments, the liquid nutritional composition has a pH ranging from about 2.0 to about 4.6, including from about 2.9 to about 4.2, and also including from about 2.8 to about 3.4. Within these pH ranges, the formation of sediment, gelation, and coagulation is minimized or avoided even at temperatures greater than 82° C., which is one preferred minimum temperature for a suitable process for acidified products, as described below. More specifically, the liquid nutritional composition may be processed at a temperature range between 110° C. to 113° C. for example.

The liquid nutritional composition is a substantially clear liquid, i.e., a non-emulsified or similar other liquid having a visibly clear or translucent appearance. In particular, the liquid nutritional composition typically remains substantially clear when in a dispersion or a solution, so as not to make the finished product cloudy. In certain embodiments, the liquid nutritional composition may be turbid. The liquid nutritional composition may have a turbidity FNU of less than or equal to 5,000 (e.g., 50 to 5,000), including less than or equal to 4,000 (e.g., 50 to 4,000), less than or equal to 3,000 (e.g., 50 to 3,000), less than or equal to 2,000 (e.g., 50 to 2,000), less than or equal to 1,000 (e.g., 50 to 1,000), less than or equal to 750 (e.g., 10 to 750), less than or equal to 500 (e.g., 10 to 500), less than or equal to 300 (e.g., 10 to 300), less than or equal to 250 (e.g., 10 to 250), less than or equal to 100 (e.g., 10 to 100), less than or equal to 50 (e.g., 3 to 50), less than or equal to 40 (e.g., 3 to 40), less than or equal to 30 (e.g., 3 to 30), and less than or equal to 20 (e.g., 0 to 20).

The liquid nutritional composition may be and typically is shelf stable. In some exemplary embodiments, the liquid nutritional composition contains up to about 95% by weight of water, including from about 50% to about 95%, including from about 60% to about 90%, and also including from about 70% to about 85% of water by weight of the liquid nutritional composition.

In some exemplary embodiments, the liquid nutritional composition is formulated with sufficient kinds and amounts of nutrients so as to provide a supplemental source of nutrition, or to provide a specialized nutritional liquid for use in individuals afflicted with specific diseases or conditions. The liquid nutritional composition may thus have a variety of product densities, for example, a density greater than about 1.04 g/ml, including from about 1.06 g/ml to about 1.12 g/ml, and also including from about 1.09 g/ml to about 1.10 g/ml.

In some exemplary embodiments, the liquid nutritional composition has a caloric density tailored to the nutritional needs of the ultimate user, although in many instances the composition comprises from about 0.38 kcal/ml to about 2.08 kcal/ml, including from about 0.63 kcal/ml to about 1.46 kcal/ml, including from about 0.75 kcal/ml to about 1.46 kcal/ml and also including from about 1.04 kcal/ml to about 1.33 kcal/ml. In other embodiments, the liquid nutritional composition comprises from about 0.19 kcal/ml to about 1.04 kcal/ml, including from about 0.31 kcal/ml to about 0.73 kcal/ml, and also including from about 0.52 kcal/ml to about 0.67 kcal/ml.

Although the serving size for the liquid nutritional composition can vary depending upon a number of variables, a typical serving size ranges from about 100 ml to about 591 ml, including from about 150 to about 250 ml, and including from about 190 ml to about 240 ml. Some specific exemplary serving sizes for the liquid nutritional composition include 240 ml (8.1 ounces), 296 ml (10 ounces) and 480 ml (16 ounces).

### Protein

The total concentration of protein in the liquid nutritional composition is controlled so as to not exceed about 10%, and may range from about 0.5% to about 10%, including from about 1% to about 10%, including from about 2% to about 10%, including from about 3% to about 10%, including from about 4% to about 10%, and also including from about 5% to about 10%, by weight of the liquid nutritional composition.

In some exemplary embodiments, the sole source of protein for the liquid nutritional composition is whey protein. In these embodiments, non-limiting examples of the whey protein include whey protein isolate, whey protein concentrate, hydrolyzed whey protein, and combinations thereof.

In addition, the whey protein may be combined with an additional source of protein in an amount sufficient to provide the desired amount of total protein (e.g., 1 g to 8 g of protein) per serving. Non-limiting examples of additional suitable proteins or sources thereof for use in the liquid nutritional composition include hydrolyzed or partially hydrolyzed proteins or protein sources, which may be derived from any known or otherwise suitable source such as milk (e.g., casein), animal (e.g., meat, fish), cereal (e.g., rice, corn), vegetable (e.g., soy, potato, pea), and combinations thereof. Non-limiting examples of the additional source of protein include acid caseins, sodium caseinates, calcium caseinates, potassium caseinates, casein hydrolysates, milk protein concentrates, milk protein isolates, milk protein hydrolysates, nonfat dry milk, condensed skim milk, soy protein concentrates, soy protein isolates, soy protein hydrolysates, pea protein concentrates, pea protein isolates, pea protein hydrolysates, collagen proteins, insect proteins, earthworm proteins, and combinations thereof.

### Carbohydrate

In some exemplary embodiments, the liquid nutritional composition may further comprise any carbohydrates or sources thereof that are suitable for use in an oral nutritional composition and are compatible with the elements and features of such compositions. When present in the liquid nutritional composition, the carbohydrate concentration may range, for example, from about 5% to about 50%, including at least about 1%, at least about 5%, at least about 8%, at least about 9%, at least about 10%, at least about 15%, at least about 20%, at least about 25%, up to about 30%, up to about 35%, up to about 40%, up to about 45%, or up to about 50%, by weight of the liquid nutritional composition.

Non-limiting examples of suitable carbohydrates or sources thereof for use in the nutritional composition include maltodextrin (e.g., maltodextrin having a dextrose equivalent (“DE”) number ranging from 4 to 20), corn maltodextrin, sucromalt, maltitol powder, glycerine, glucose polymers, corn syrup, corn syrup solids (e.g., corn syrup solids having a DE number of at least 21), modified starches, resistant starches, rice-derived carbohydrates (e.g., tapioca dextrin), isomaltulose, sucrose, monk fruit, extra fine white sugar, glucose, fructose, lactose, high fructose corn syrup, honey, sugar alcohols (e.g., maltitol, erythritol, sorbitol), artificial sweeteners (e.g., sucralose, acesulfame potassium, stevia, alitame, aspartame, sodium cyclamate, dulcin, glucin, neotame, saccharin), fructooligosaccharides, soy fiber, corn fiber, guar gum, konjac flour, polydextrose, Fibersol, and combinations thereof.

### Fat

In some exemplary embodiments, the liquid nutritional composition is substantially free of fat; that is, the liquids are devoid of added fat except for any fat inherent to the raw materials or otherwise added at low concentrations to aid in the manufacture of the composition.

### Vitamins

The liquid nutritional composition will typically include a nutritionally significant quantity of one or more vitamins; however, the liquid nutritional composition will be substantially free of vitamin C. In particular, the liquid nutritional composition will typically comprise vitamins or related nutrients, non-limiting examples of which include vitamin A, vitamin D, vitamin E, vitamin K, thiamine, riboflavin, pyridoxine, vitamin B12, carotenoids, niacin, folic acid, pantothenic acid, biotin, choline, inositol, salts, derivatives thereof, and combinations thereof.

As described herein, the liquid nutritional composition will not have a nutritionally significant amount of vitamin C and will typically be free of vitamin C. In some exemplary embodiments, the liquid nutritional composition comprises at least one vitamin other than vitamin C. In some exemplary embodiments, the liquid nutritional composition comprises a plurality of vitamins, other than vitamin C. In some exemplary embodiments, the liquid nutritional composition comprises a plurality of vitamins selected from the group consisting of vitamin A, vitamin B1, vitamin B2, vitamin B3, vitamin B5, vitamin B6, vitamin B7, vitamin B9, vitamin B12, vitamin D, vitamin E, and vitamin K. In some exemplary embodiments, the liquid nutritional compositions comprises at least ten vitamins selected from the group consisting of vitamin A, vitamin B1, vitamin B2, vitamin B3, vitamin B5, vitamin B6, vitamin B7, vitamin B9, vitamin B12, vitamin D, vitamin E, and vitamin K.

### Minerals

In some exemplary embodiments, the liquid nutritional composition comprises at least one mineral. In some exemplary embodiments, the liquid nutritional composition comprises a plurality of minerals. In some exemplary embodiments, the liquid nutritional composition comprises four or more minerals.

### Acidulants

The liquid nutritional composition will typically include an acidulant; however, the liquid nutritional composition will be substantially free of citric acid. The acidulant impacts the acidity of the liquid nutritional composition and plays a role in its flavor profile. In some exemplary embodiments, the liquid nutritional composition comprises at least one acidulant other than citric acid. Examples of suitable food grade acids include, but are not limited to, acetic acid, fumaric acid, lactic acid, malic acid, phosphoric acid, and tartaric acid.

In some exemplary embodiments, malic acid is the sole acidulant found in the liquid nutritional composition. In particular, in some exemplary embodiments, the liquid nutritional composition comprises malic acid and is substantially free of citric acid. In some exemplary embodiments, malic acid and at least one other acidulant (e.g., citric acid, phosphoric acid) are present in the liquid nutritional composition, wherein the concentration of the malic acid will typically exceed the concentration of each other acidulant found in the composition. In some exemplary embodiments, the concentration of the malic acid will exceed the combined concentration of all other acidulants in the composition. It has been found that the use of malic acid, along with excluding vitamin C and limiting the amount of overall protein, in the liquid nutritional composition results in improved sensory characteristics as described and suggested herein.

### Hydrocolloids

In some exemplary embodiments, the liquid nutritional composition may further comprise a water-soluble hydrocolloid. The hydrocolloid may further improve the sensory characteristics of the liquid nutritional composition, for example, by reducing an average astringency of the liquid nutritional composition. In some exemplary embodiments, the water-soluble hydrocolloid is negatively charged. In some exemplary embodiments, the water-soluble hydrocolloid is neutral. In some exemplary embodiments, the water-soluble hydrocolloid is selected from the group consisting of guar gum, pectin, gellan gum, carboxymethyl cellulose, xanthan gum, agar, alginate, arabinoxylan, carrageenan, curdlan, β-glucan, gum arabic, locust gum, starch, and combinations thereof.

### Other Additives

In some exemplary embodiments, the liquid nutritional composition may further comprise other therapeutic ingredients. Many such therapeutic ingredients are known to be suitable for use in other liquid nutritional compositions and may also be used in the liquid nutritional composition described herein, provided that such optional therapeutic ingredients are safe and effective for oral administration and are compatible with the other ingredients in the selected product form. One example of a therapeutic ingredient is beta-hydroxy beta-methylbutyric acid (HMB). Another example of a therapeutic ingredient is green tea extract. In some instances, the therapeutic ingredients may also include without limitation natural flavors, artificial flavors, artificial colorants, natural colorants, and combinations thereof.

### Other Optional Ingredients

In some exemplary embodiments, the liquid nutritional composition may also include one or more flavoring or masking agents. For example, the liquid nutritional composition can comprise up to 2% by weight of a flavoring agent. Suitable flavoring agents for use with the exemplary embodiments of the liquid nutritional composition include, for example, vanilla, cocoa, vanillin, salt, coffee, chocolate flavoring, berry flavors, fruit flavors, caramel, mint, natural sweeteners (e.g., stevia, monk fruit), artificial sweeteners (e.g., sucralose, acesulfame potassium), and combinations thereof.

The liquid nutritional composition described herein may further comprise other optional ingredients that may modify the physical, chemical, hedonic, or processing characteristics of the products or serve as pharmaceutical or additional nutritional components when used in the targeted population. Many such optional ingredients are known or otherwise suitable for use in other nutritional products and may also be used in the liquid nutritional composition described herein, provided that such optional ingredients are safe and effective for oral administration and are compatible with the essential and other ingredients in the selected product form.

Non-limiting examples of such optional ingredients include preservatives, antioxidants, emulsifying agents, buffers, pharmaceutical actives, additional nutrients, colorants, flavors, thickening agents, stabilizers, and so forth.

### Methods of Manufacture

The liquid nutritional composition may be manufactured by any known or otherwise suitable method for making acidic beverages, including acidic, shelf-stable beverages, such as retort, aseptic filling, and hot fill processes. In one exemplary embodiment, a hot fill process as described below is utilized.

In one exemplary embodiment, the protein component is first dissolved in water at a temperature ranging from room temperature (approximately 21° C.) up to 52° C., for example. Once the protein is dissolved and a slurry formed, the resulting slurry is adjusted to a pH range of from about 2.8 to about 4.2 using an appropriate acid system, such as for example malic acid and phosphoric acid.

A second slurry is prepared by dissolving the carbohydrate component in water at an elevated temperature such as 79° C., for example. Once the carbohydrate component is dissolved, the protein slurry and the carbohydrate slurry are homogenized and vitamins, minerals, and/or other ingredients are added into the resulting slurry. Once a final homogenized slurry is prepared, the resulting slurry is heated to a temperature of at least about 82° C., and more desirably at least about 93° C., and held at that temperature for at least about 20 seconds to kill mold, bacteria, and yeast. Prior to filling a suitable plastic or other container with the hot liquid, the liquid may optionally be rapidly cooled to 60° C. to 66° C. The liquid nutritional composition may be hot filled into the container by heating the slurry to 95° C. to 96° C. and holding it at that temperature for at least about 6 seconds, then cooling the liquid nutritional composition to 21° C. The liquid nutritional composition may be aseptically processed by heating the slurry to 110° C. to 113° C. and holding it at that temperature for at least about 5 seconds, then cooling the liquid nutritional composition to 21° C. By filling the hot liquid into the container, the container itself is also sterilized. Generally, during or after the filling of the hot liquid, the container is rotated so that the headspace area is also sterilized.

### Methods of Use

The liquid nutritional composition may be utilized by any person who could benefit from the use of a substantially clear nutritional liquid including whey protein. The liquid nutritional composition may be particularly suitable for individuals suffering from malnutrition and/or muscle wasting, or suffering from conditions such as fat restrictive diets, cancer, disease related malnutrition, short bowel syndrome, inflammatory bowel syndrome, cachexia, as well as other conditions or diseases. The nutritional composition is also suitable for use in healthy individuals, including athletes and other physically active individuals in whom the product benefits can be realized.

The liquid nutritional composition may be consumed by a subject, typically a human being. The human being may be any age. In some exemplary embodiments, the nutritional composition is particularly suited for adult human beings or human beings who are at least two years old. In some exemplary embodiments, the human being is at least twelve years old. In some exemplary embodiments, the human being is greater than eighteen years old. More specifically, the human being may be at least two years old, or at least three years old, or at least four years old, or at least five years old, and so forth up to any conceivable age.

### EXAMPLES

The following examples illustrate exemplary embodiments and features of various liquid nutritional compositions encompassed by the general inventive concepts. The examples are given solely for the purpose of illustration and are not to be construed as limiting the present disclosure, as many variations thereof are possible and also encompassed by the general inventive concepts. All exemplified amounts are weight percentages based upon the total weight of the composition, unless otherwise specified.

The exemplary liquid nutritional compositions were prepared in accordance with the manufacturing methods described herein, such that each exemplified composition can be formed as a hot filled product and/or formed as an aseptically processed product. These compositions are typically substantially clear or turbid nutritional liquids packaged in 240 ml plastic containers or 296 ml containers. However, other sizes and types of containers may be suitable. Each formulation in these examples has a pH range of about 2.0 to about 4.6.

### Example 1

Example 1 illustrates a substantially clear nutritional composition including whey protein, the ingredients of which are listed in Table 1. All ingredient amounts are listed as kilogram per 1,000 kilogram batch of product, unless otherwise specified.

TABLE 1
Exemplary Bill of Materials

| | APPROXIMATE | |
|---|---|---|
| | AMOUNT | |
| INGREDIENTS | PER 1000 KG | |
| Ingredient Water | Q.S. | |
| Liquid Sucrose (67.5% TS) | 78.8 | kg |
| Maltrin M180 | 64.6 | kg |
| Bevwise A100W | 31.7 | kg |
| Givaudan N&A Peach XK-075-569-3 | 2.00 | kg |
| Malic Acid | 1.50 | kg |
| Liquid Sucralose (25%)-Ross | 275.0 | g |
| UTM/TM Premix¹ | 230.0 | g |

¹The UTM/TM Premix provides a source of: zinc, iron, manganese,
copper, chromium, molybdenum, and selenium.

| | | |
|---|---|---|
| Water Dispersible ADEK Premix¹ | 178.0 | g |
| Acesulfame Potassium | 110.0 | g |
| XFO-380 non-silicone antifoam (processing | 60.0 | g |
| aid) | | |
| Sensient Orange Liquid Color 00404 | 41.7 | g |
| WSV Vitamin Premix² | 40.9 | g |
| Sensient Red Liquid Color 00401 | 17.2 | g |
| Folic Acid | 1.3 | g |
| Potassium Iodide | 204.0 | mg |

¹The ADEK Premix provides a source of: vitamin A, vitamin D,
vitamin E, and vitamin K.
²The WSV Vitamin Premix provides a source of: vitamin B1,
vitamin B2, vitamin B3, vitamin B5, vitamin B6, vitamin B7, vitamin B9,
and vitamin B12.

### Examples 2-6

In an effort to reduce off-notes (e.g., undesirable flavors) found in conventional clear liquid nutritional beverages, the inventors evaluated the impact that removing different individual vitamins and minerals had on the overall sensory characteristics of a clear liquid nutritional beverage. Surprisingly, removal of only the vitamin C from the clear liquid nutritional beverage had a significant impact on reduction or elimination of metallic off-notes in the beverage. Consequently, significant improvement in the organoletpic properties of the clear liquid nutritional beverage, without major changes in the nutritional profile, was achieved. In support of this conclusion, a panel of trained, certified sensory panelists evaluated five prototype formulations without vitamin C (i.e., Examples 2-6) against a reference formulation including vitamin C. The results, which are shown in Tables 2A and 2B, indicate a moderate reduction in metallic off-notes in the five prototype formulations.

TABLE 2A
Sensory Data for Examples 2-4

| | | | Example 3 | Example 4 |
|---|---|---|---|---|
| | | | No Vitamin C, | No Vitamin C, |
| | | Example 2 | Malic Acid, | Malic Acid, |
| | Reference | No Vitamin C, | 0.065% | 0.0975% |
| | Formulation | Malic Acid | GuarNT | GuarNT |
| Appearance | Dark purple red, | Slightly lighter | Slightly more | Similar |
| | thin and water | color | purple | |
| | like, very slightly | | | |
| | translucent, | | | |
| | slight to | | | |
| | moderate cloudy | | | |
| Aroma | Moderate berry, | Slightly more | Slightly less | Slightly lower |
| | slight sweet | sweet aromatic, | vitamin | aroma overall |
| | aromatic, slight | slightly different | | with similar |
| | powdery aroma, | berry character | | characteristics |
| | slight vitamin | (more artificial) | | |
| Flavor | Moderate sweet, | Slight to | Slightly more | Slightly sweeter, |
| | slight to | moderately less | sweet, slightly | slightly less |
| | moderate sour, | sour, slightly | less sour, slightly | vitamin, very |
| | moderate berry, | more sweet, | less bitter, | slightly less sour, |
| | slight bitter, | slight to | slightly different | slightly less |
| | slight vitamin, | moderately less | berry character | metallic |
| | slight metallic | bitter, slightly | (candy-like, | |
| | | different berry | slight woody), | |
| | | character (more | slightly different | |
| | | artificial), | vitamin character | |
| | | moderately less | | |
| | | vitamin | | |
| Texture | Moderate | Slightly less | Similar | Similar |
| | astringent, slight | astringent, | | |
| | to moderate | slightly less | | |
| | chalky, thin and | chalky | | |
| | water-like | mouthcoating | | |
| Difference from | | Slight to | Slight Difference | Slight Difference |
| Reference | | Moderate | | |
| Formulation | | Difference | | |
| Conclusion | | Compared to the | Compared to the | Compared to the |
| | | reference, the test | reference, the test | reference, the test |
| | | sample flavor | sample was | sample was |
| | | was slight to | slightly more | slightly sweeter, |
| | | moderately less | sweet, slightly | had slightly less |
| | | sour, slightly | less sour, slightly | vitamin flavor, |
| | | more sweet, | less bitter, had a | was very slightly |
| | | slight to | slightly different | less sour and was |
| | | moderately less | berry character | slightly less |
| | | bitter, had a | (candy-like, | metallic. The test |
| | | slightly different | slight woody) | sample texture |
| | | berry character | and had a | was similar to the |
| | | (more artificial), | slightly different | Reference |
| | | and had | vitamin | sample. |
| | | moderately less | character. The | |
| | | vitamin flavor. | test sample | |
| | | The test sample | texture was | |
| | | texture was | similar to the | |
| | | slightly less | reference sample. | |
| | | astringent, and | | |
| | | had a slightly | | |
| | | less chalky | | |
| | | mouthcoating. | | |

TABLE 2B
Sensory Data for Examples 5-6

| | | Example 5 | Example 6 |
|---|---|---|---|
| | | No Vitamin C, | No Vitamin C, |
| | Reference | Malic Acid, | Malic Acid, 8 g |
| | Formulation | 0.13% GuarNT | protein/10 oz. |
| Appearance | Dark purple red, | Slightly more | Slightly more red |
| | thin and water | purple | |
| | like, very slightly | | |
| | translucent, | | |
| | slight to | | |
| | moderate cloudy | | |
| Aroma | Moderate berry, | Slight to | Slightly lower |
| | slight sweet | moderately | aroma overall, |
| | aromatic, slight | different berry | slight to |
| | powdery aroma, | character (more | moderately less |
| | slight vitamin | artificial), slight | vitamin |
| | | to moderately | |
| | | less vitamin | |
| Flavor | Moderate sweet, | Slight to | Slight to |
| | slight to | moderately | moderately |
| | moderate sour, | sweeter, slight | sweeter, slight to |
| | moderate berry, | less sour, slight | moderately less |
| | slight bitter, | to moderately | sour, moderately |
| | slight vitamin, | less vitamin, | less bitter, |
| | slight metallic | slight to | slightly less |
| | | moderately | berry, slightly |
| | | different berry | less metallic |
| | | character (more | |
| | | artificial) | |
| Texture | Moderate | Slight to | Moderately less |
| | astringent, slight | moderately less | astringent, slight |
| | to moderate | chalky, slightly | to moderately |
| | chalky, thin and | less astringent | less chalky, |
| | water-like | | slightly thinner |
| Difference | | Slight to | Moderate |
| from | | Moderate | Difference |
| Reference | | Difference | |
| Formulation | | | |
| Conclusion | | Compared to the | Compared to the |
| | | reference, the test | reference, the test |
| | | sample was | sample flavor |
| | | slight to | was slight to |
| | | moderately | moderately |
| | | sweeter, slightly | sweeter, slight to |
| | | less sour, had | moderately less |
| | | slight to | sour, moderately |
| | | moderately less | less bitter, had |
| | | vitamin aroma | slightly less |
| | | and flavor, and | berry, and was |
| | | contained a | slightly less |
| | | slightly to | metallic. The test |
| | | moderately | sample texture |
| | | different berry | was moderately |
| | | character (more | less astringent, |
| | | artificial). The | slight to |
| | | test sample | moderately less |
| | | texture was slight | chalky and |
| | | to moderately | slightly thinner. |
| | | less chalky and | |
| | | slightly less | |
| | | astringent. | |

### Example 7

Consumer testing was also used to evaluate formulations in accordance with the general inventive concepts. In particular, a test formulation (Example 7) of a substantially clear liquid nutritional composition containing 8 g of protein and no vitamin C was tested against a control formulation containing 9 g of protein and 45% DV of vitamin C. 114 individuals sampled the test and control formulations. Respondents were asked to rate their overall liking after one sip and then again after drinking the full serving (10 fl oz). Table 3 shows the overall liking scores for the test and control formulations. The overall liking scale goes from 1=Extremely Dislike to 9=Extremely Like. The overall liking score for the test formulation (with 8 g of protein and no vitamin C) scored significantly higher than the control formulation (with 9 g of protein and 45% DV of Vitamin C). The results presented in Table 4 show that less people (30 people) noticed an undesirable “Nutritional Drink Taste” in the test formulation, which does not contain vitamin C, versus the control formulation (50 people), which does contain Vitamin C.

TABLE 3
Overall Liking Scores for Example 7

| | Con- | Prototype 1 | | Confidence |
|---|---|---|---|---|
| | trol | (8 g protein) | P-Value | Level |
| TOTAL | 114 | | | |
| OVERALL | 7.37 | 7.50 | 0.4937 | NSD |
| LIKING-INITIAL (9-1)+ | | | | |
| Means | | | | |
| OVERALL LIKING-FULL | b | a | 0.0424 | * |
| SERVING (9-1)+ | 6.96 | 7.42 | | |
| Means | | | | |

+Liking scale: 9 = Like extremely . . . 1 = Dislike extremely
Analysis of Variance Confidence Levels: * = 95%
NSD: Not significantly different at the 95% confidence level.
Mean ratings with different superscripts differ significantly at the 95% confidence level (Tukey's HSD Test).

TABLE 4
Liking Ratings for Example 7

| | | Prototype 1 | | Confidence |
|---|---|---|---|---|
| | Control | (8 g protein) | P-Value | Level |
| TOTAL | 114 | | | |
| SWEETNESS | 6.39 | 6.71 | 0.1827 | NSD |
| LIKING (9-1)+ | | | | |
| Means | | | | |
| TOTAL # WHO | 50 | 30 | | |
| NOTICED | | | | |
| NUTRITIONAL | | | | |
| DRINK TASTE | | | | |
| LIKING OF | 5.82 | 6.73 | 0.1880 | NSD |
| NUTRITIONAL DRINK | | | | |
| TASTE (9-1)+ | | | | |
| Means | | | | |
| TOTAL # WHO | 42 | 35 | | |
| NOTICED | | | | |
| ASTRINGENT/DRY | | | | |
| MOUTHFEEL | | | | |
| LIKING OF AS | 3.91 | 3.89 | 0.7832 | NSD |
| TRINGENT/DRY | | | | |
| MOUTHFEEL (9-1)+ | | | | |
| Means | | | | |

+Liking scale: 9 = Like extremely . . . 1 = Dislike extremely
Analysis of Variance Confidence Levels: * = 95%
NSD: Not significantly different at the 95% confidence level.
Mean ratings with different superscripts differ significantly at the 95% confidence level (Tukey's HSD Test).

The general inventive concepts have been illustrated, at least in part, by describing various exemplary embodiments thereof. While these exemplary embodiments have been described in considerable detail, they are not intended to restrict or in any way limit the scope of the appended claims to such detail. Furthermore, in some exemplary embodiments, it may be possible to utilize the various inventive concepts in combination with one another (e.g., one or more of the exemplary embodiments may be utilized in combination with each other). Additionally, any particular element recited as relating to a particularly disclosed embodiment should be interpreted as available for use with all disclosed embodiments, unless incorporation of the particular element would be contradictory to the express terms of the embodiment. Additional advantages and modifications will be readily apparent to those skilled in the art. Therefore, the disclosure, in its broader aspects, is not limited to the specific details presented therein, the representative embodiments, or the illustrative examples shown and described. Accordingly, departures may be made from such details without departing from the spirit or scope of the general inventive concepts.

To the extent that the terms “include,” “includes,” or “including” are used in the specification or the claims, they are intended to be inclusive in a manner similar to the term “comprising” as that term is interpreted when employed as a transitional word in a claim. Furthermore, to the extent that the term “or” is employed (e.g., A or B), it is intended to mean “A or B or both A and B.” When the applicants intend to indicate “only A or B but not both,” then the term “only A or B but not both” will be employed. Thus, use of the term “or” herein is the inclusive, and not the exclusive use. Also, to the extent that the terms “in” or “into” are used in the specification or the claims, it is intended to additionally mean “on” or “onto.” Furthermore, to the extent that the term “connect” is used in the specification or the claims, it is intended to mean not only “directly connected to,” but also “indirectly connected to” such as connected through another component or components. In the present disclosure, the words “a” or “an” are to be taken to include both the singular and the plural. Conversely, any reference to plural items shall, where appropriate, include the singular.

All percentages, parts, and ratios as used herein as they pertain to listed ingredients are based on the active level and, therefore, do not include solvents or by-products that may be included in commercially available materials, unless otherwise specified.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more (e.g., 1 to 6.1), and ending with a maximum value of 10 or less (e.g., 2.3 to 9.4, 3 to 8, 4 to 7), and finally to each number 1, 2, 3, 4, 5, 6, 7, 8, 9, and 10 contained within the range.

All combinations of method or process steps as used herein can be performed in any order, unless otherwise specified or clearly implied to the contrary by the context in which the referenced combination is made.

The substantially clear nutritional liquids and corresponding manufacturing methods of the present disclosure can comprise, consist of, or consist essentially of the essential elements of the disclosure as described herein, as well as any additional or optional element described herein or otherwise useful in substantially clear nutritional liquid applications.

What is claimed is:

1. A substantially clear liquid nutritional composition having a pH of less than or equal to 4.6, said substantially clear liquid nutritional composition comprising:
at least one source of protein, and
at least one of a vitamin and a mineral,
wherein a total protein content is 1 wt % to 10 wt % of a serving of said substantially clear liquid nutritional composition,
wherein said substantially clear liquid nutritional composition is substantially free of fat, and
wherein said substantially clear liquid nutritional composition is substantially free of vitamin C.

2. The substantially clear liquid nutritional composition of claim 1, wherein the total protein content of a serving of said substantially clear liquid nutritional composition is from 2 g to 8 g.

3. The substantially clear liquid nutritional composition of claim 1, wherein the total protein content of a serving of said substantially clear liquid nutritional composition is approximately 8 g.

4. The substantially clear liquid nutritional composition of claim 1, wherein said at least one source of protein comprises whey protein.

5. The substantially clear liquid nutritional composition of claim 4, wherein said whey protein is selected from the group consisting of whey protein isolate, whey protein concentrate, hydrolyzed whey protein, and combinations thereof.

6. The substantially clear liquid nutritional composition of claim 1, wherein the total protein content of a serving of said substantially clear liquid nutritional composition is provided by whey protein.

7. The substantially clear liquid nutritional composition of claim 1, wherein whey protein comprises from 1 wt % to 10 wt % of said substantially clear liquid nutritional composition.

8. The substantially clear liquid nutritional composition of claim 1, wherein the total protein content of a serving of said substantially clear liquid nutritional composition comprises from 65 wt % to 100 wt % soluble protein.

9. The substantially clear liquid nutritional composition of claim 1, wherein said substantially clear liquid nutritional composition comprises a plurality of vitamins.

10. The substantially clear liquid nutritional composition of claim 9, wherein said plurality of vitamins is selected from the group consisting of: Vitamin A, Vitamin D, Vitamin K, Riboflavin, Vitamin B6, Vitamin B12, Pantothenic Acid, Vitamin E, Thiamin, Niacin, Folic Acid, Biotin, and combinations thereof.

11. The substantially clear liquid nutritional composition of claim 1, wherein said substantially clear liquid nutritional composition comprises a plurality of minerals.

12. The substantially clear liquid nutritional composition of claim 11, wherein said plurality of minerals is selected from the group consisting of: Calcium, Iodine, Zinc, Copper, Chromium, Iron, Phosphorus, Magnesium, Selenium, Manganese, Molybdenum, and combinations thereof.

13. The substantially clear liquid nutritional composition of claim 1, wherein said substantially clear liquid nutritional composition comprises a plurality of vitamins and a plurality of minerals.

14. The substantially clear liquid nutritional composition of claim 1, wherein said pH is between 2 and 4.6.

15. The substantially clear liquid nutritional composition of claim 1, wherein said pH is between 2.8 and 3.4.

16. The substantially clear liquid nutritional composition of claim 1, further comprising an acidulant.

17. The substantially clear liquid nutritional composition of claim 16, wherein said acidulant is selected from the group consisting of: citric acid, malic acid, phosphoric acid, and combinations thereof.

18. The substantially clear liquid nutritional composition of claim 16, wherein said substantially clear liquid nutritional composition comprises malic acid and is substantially free of citric acid.

19. The substantially clear liquid nutritional composition of claim 1, further comprising at least one source of carbohydrate.

20. The substantially clear liquid nutritional composition of claim 19, wherein said at least one source of carbohydrate is selected from the group consisting of: sucrose, maltodextrin, corn syrup solids, maltodextrin, sucromalt, maltitol powder, glycerine, glucose polymers, corn syrup, modified starches, resistant starches, rice-derived carbohydrates, isomaltulose, white sugar, glucose, fructose, lactose, high fructose corn syrup, honey, sugar alcohols, fructooligosaccharides, soy fiber, corn fiber, guar gum, konjac flour, polydextrose, Fibersol, and combinations thereof.

21. The substantially clear liquid nutritional composition of claim 1, further comprising at least one ingredient selected from the group consisting of natural flavors, artificial flavors, natural colorants, artificial colorants, natural sweeteners, artificial sweeteners, and combinations thereof.

22. The substantially clear liquid nutritional composition of claim 1, further comprising at least one high intensity sweetener.

23. The substantially clear liquid nutritional composition of claim 22, wherein said at least one high intensity sweetener is selected from the group consisting of: sucralose, stevia, monk fruit, acesulfame potassium, and combinations thereof.

24. The substantially clear liquid nutritional composition of claim 1, wherein said substantially clear liquid nutritional composition comprises less than 1 wt % of fat.

25. The substantially clear liquid nutritional composition of claim 1, wherein said substantially clear liquid nutritional composition is shelf stable.
